(19) United States
(12) Patent Application Publication
(10) Pub. No.: US 2017/0291164 A1
(43) Pub. Date: Oct. 12, 2017

(54) IMPROVED AIR PURIFICATION SYSTEM AND METHOD FOR REMOVING FORMALDEHYDE

(71) Applicants: Yiling ZHANG, Oceanside, CA (US); NITTO DENKO CORPORATION, Osaka (JP)

(72) Inventor: Yiling Zhang, Oceanside, CA (US)

(21) Appl. No.: 15/509,785

(22) PCT Filed: Sep. 10, 2015
(86) PCT No.: PCT/US15/49472

§ 371 Date: Mar. 8, 2017

Related U.S. Application Data
(60) Provisional application No. 62/048,707, filed on Sep. 10, 2014.

(51) Int. Cl. B01J 23/63; B01D 53/88; B01J 23/10; B01J 35/00; B01J 37/08; B01J 37/34; B01J 37/02; B01J 37/00; B01J 37/06; B01D 53/86; B01J 37/04

(52) U.S. Cl. CPC B01J 23/63; B01D 53/8668; B01D 53/885; B01J 23/10; B01J 35/004; B01J 37/04; B01J 37/343; B01J 37/0215; B01J 37/0236; B01J 37/344; B01J 37/0209; B01J 37/009; B01J 37/06; B01J 37/08; B01D 2255/802; B01D 2255/1021; B01D 2255/2065; B01D 2257/708

(57) ABSTRACT

A system for decomposing contaminants, including volatile compounds (VOCs), with a visible-spectrum photocatalytic composition.

### THE RELEVANT FIELD

The present disclosure generally relates to reduction of contaminants in air. More particularly, the present disclosure pertains to an element for reducing the concentration of formaldehyde in air using an improved photocatalytic composition.

### BACKGROUND

Photocatalysts are an effective way to reduce the concentration of gases such as formaldehyde, and other contaminants in the air. This is desirable because formaldehyde gas is believed to be a consideration in sick-building syndrome. Various ways of controlling concentrations of formaldehyde have been employed in the past, including filters, oxidizers, thermocatalysts, and photocatalysts.

Filters have typically been made from activated carbon or zeolite, and function by physically trapping the contaminant to remove it from the air. One problem with filters is that as they work, the filter necessarily becomes clogged, loses efficacy, and needs to be replaced.

Oxidizers suffer from a similar drawback to filters in that they are consumable; they are used up as they work and must be replaced from time to time to maintain their efficacy.

Thermocatalysts are used in industrial settings for formaldehyde removal. The drawback of such catalysts is the necessity of elevated temperatures well above room temperature (20-25° C.) for effective operation. This factor limits practical applications of such catalysts in a common household setting.

The discussed shortcomings of the technologies currently in use show there is a need for a more effective visible-spectrum photocatalyst.

### SUMMARY

Disclosed herein are methods of using a visible light photocatalyst to irradiate CeO₂ and/or MnO₂ and reduce the formaldehyde levels in air samples.

Some embodiments include a photocatalytic element for removing and/or decomposing contaminants, including, but not limited volatile organic compounds and/or gases, and a method of purifying the air by removing and/or decomposing contaminants in the air. The embodiments include a photocatalytic element comprising a visible light photocatalytic and adsorbent metal oxide. In some embodiments, the photocatalytic element comprises a visible light photocatalytic and adsorbent metal oxide; and an irradiating element, the irradiating element in optical communication with the sample and visible light photocatalytic and adsorbent metal oxide, e.g., cerium oxide or manganese oxide, with light between 380 nm and 525 nm.

The embodiments include an element comprising at least a visible light photocatalytic and adsorbent material disposed over a substrate, used to effectively reduce contaminants in the air by decomposing and/or oxidizing a contaminant when the photocatalytic element is illuminated by visible-spectrum light and in contact with a contaminant. The embodiments can be more effective at removing or decomposing volatile organic compounds, inorganic compounds, and/or gas levels (e.g., formaldehyde) than the filters and compositions used to date.

In some embodiments, a method for removing or decomposing an aldehyde, e.g., formaldehyde, as described herein is provided. In other embodiments, the method may comprise contacting a sample with a composition comprising a visible light photocatalytic and adsorbent metal oxide; and exposing the sample to light between 380 nm to about 525 nm. In some embodiments, the photocatalytic and adsorbent metal oxide can be selected from cerium oxide and manganese oxide. In some embodiments, the composition comprises a catalytic and adsorbent metal oxide and may be at least 70% metal oxide.

Some embodiments include a method for removing formaldehyde comprising: contacting a sample with a composition comprising a visible light photocatalyst comprising a metal oxide that is adsorbent to aldehydes, and wherein the metal of the metal oxide has an atomic number of 23 to 80; and exposing the sample to light between about 380 nm to about 525 nm.

Some embodiments include an element for removing formaldehyde from a sample comprising: a photocatalytic element comprising a visible light photocatalyst comprising a metal oxide that is adsorbent to aldehydes, wherein the metal of the metal oxide has an atomic number of 23 to 80; and an irradiating element, wherein the irradiating element is in optical communication with the sample and cerium oxide with light between about 380 nm and 525 nm.

Some embodiments include a device for removing an aldehyde from air comprising the photocatalytic element in fluid communication with the air containing the aldehyde to be removed.

The element for decomposing formaldehyde of the disclosed embodiments may be formed by disposing a photocatalytic composition over a substrate. In some embodiments, the photocatalytic element/composition comprises a photocatalyst, wherein the photocatalyst may be CeO₂. A photocatalyst includes any material that may activate or change the rate of a chemical reaction as a result of exposure to light, such as ultraviolet or visible light.

### BRIEF DESCRIPTION OF THE DRAWINGS

FIG. 1 is a schematic depiction of an embodiment of a photocatalytic coating.

FIG. 2 is a plot of formaldehyde decomposition for the photocatalyst compositions of Example 1.

FIG. 3 is a plot of CO₂ generation/formaldehyde decomposition over 18 hours for a photocatalyst composition comprising CeO₂.

FIG. 4 is a plot of CO₂ generation/formaldehyde decomposition after 60 minutes of exposure to a photocatalyst composition comprising CeO₂.

### DETAILED DESCRIPTION

Photocatalysts can be used in combination with ultraviolet or visible illumination. Some photocatalytic systems include TiO₂ or WO₃ in combination with metal oxides. The increase in indoor lighting that is UV-free leads to a growing need for photocatalysts that are effective in the visible spectrum.

Some methods for removing and/or decomposing an aldehyde comprise contacting a sample with a composition comprising a visible light photocatalyst comprising an adsorbent metal oxide that is adsorbent to aldehydes; and exposing the sample to light between about 380 nm to about 525 nm or about 447 nm to about 457 nm. In some embodiments, the metal oxide may be cerium oxide and/or manganese oxide. In some embodiments, the composition may be at least 70% metal oxide.

In some embodiments, an element for decomposing and/or, removing an aldehyde, e.g., formaldehyde, from a sample may comprise a photocatalytic and adsorbent metal oxide; and an irradiating element, the irradiating element in optical communication with the sample and metal oxide, or the irradiating element may emit light that contacts both the sample and the metal oxide, the irradiating element emitting light between about 380 nm to about 525 nm or about 447 nm to about 457 nm.

A photocatalyst includes any material that can activate or change the rate of a chemical reaction as a result of exposure to light, such as visible light. Traditionally, photocatalysts could be activated only by light in the UV range, i.e., having a wavelength less than about 380 nm. This is because of the wide bandgap (>3 eV) of most semiconductors. However, by appropriately selecting materials or modifying existing photocatalysts, visible light photocatalysts can be synthesized. A visible light photocatalyst includes a photocatalyst that is activated by visible light, e.g. light that is normally visually detectable by the unaided human eye, such as at least about 380 nm in wavelength. Visible light photocatalysts can also be activated by UV light below 380 nm in wavelength in addition to visible wavelengths. Some visible light photocatalyst may have a bandgap that corresponds to light in the visible range, such as a band gap greater than about 1.5 eV; less than about 3.2 eV; about 1.5 eV to about 3.2 eV; about 1.7 eV to about 3.2 eV; or about 1.77 eV or about 1.8 eV to about 3.2 eV.

In some embodiments, the photocatalyst material may be an inorganic solid, such as a solid inorganic semiconductor, that absorbs visible light. Such a semiconductor may have a conduction band with an energy of about 1 eV to about 0 eV; about 0 eV to about −1 eV; or about −1 eV to about −2 eV, as compared to the normal hydrogen electrode. Some photocatalysts may have a valence band with energy of about 3 eV to about 3.5 eV; about 2.5 eV to about 3 eV; about 2 eV to about 3.5 eV; or about 3.5 eV to about 5.0 eV as compared to the normal hydrogen electrode.

In some embodiments, the visible light photocatalyst may comprise a metal oxide, such as a metal oxide of a metal having an atomic number of 23-80, 25-60, 23-75, 23-40, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, or any atomic number in a range bounded by any of these values. In some embodiments, the metal oxide may be ZnO, ZrO₂, SnO₂, CeO₂, SrTiO₃, BaTiO₃, In₂O₃, CuₓO, Fe₂O₃, ZnS, Bi₂O₃, WO₃, Bi₂WO₆, BiFeO₃, Mn_{y}Oₓ, TiO₂, CoₓO, V₂O₅, or BiVO₄. With respect to CuₓO, Mn_{y}Oₓ, or CoₓO, in some embodiments x may be 1, 2, or 3, and y may be 1, 2, or 3. In some embodiments, the metal oxide may be a rare earth oxide such as cerium oxide (e.g., CeO₂), alone or in combination with other metal oxides. In some embodiments, the metal oxide may comprise, or consist of, a manganese oxide, such as MnO₂. In some embodiments, the first photocatalyst essentially excludes TiO₂ and/or WO₃. In some embodiments, the photocatalytic agent comprises less than about 40%, 30%, 25%, 20%, 10%, 5%, 2.5%, or 1% TiO₂ and/or WO₃.

In some embodiments, the composition may further comprise a non-photocatalytic metal oxide. In some embodiments, the composition further comprises a noble metal, such as about 0.01% to about 10%; about 0.2% to about 5%; or about 0.5% to about 2% of noble metal based upon the total number of metal atoms in the metal oxide. In some embodiments, the noble metal may be platinum, palladium, gold, silver, iridium, ruthenium, and/or rhodium. In some embodiments, the noble metal is platinum.

In some embodiments, the metal oxide may be a material, e.g., CeO₂ and/or MnO₂, that is adsorbent to a target volatile organic compound. For example, the metal oxide may adsorb at least 0.001 mM, 0.01 mM, 0.1 mM, 0.5 mM, 0.75 mM, or 1.0 mM of the target volatile organic compound. A suitable means for determining the amount of adsorption can be by constant volume variable pressure analysis. In another means, one can measure the amount of formaldehyde that disappears by taking the amount of CO₂ increased and subtracting the amount of CO₂ from the formaldehyde to give an estimate of the adsorbed amount of formaldehyde. In some embodiments, the photocatalytic material may adsorb at least 0.1 mg, 0.5 mg, 1.0 mg, 2.0 mg, and/or at least 3.0 mg of aldehyde, e.g., formaldehyde, per gram of visible light photocatalytic material, e.g., CeO₂. In one embodiment, the photocatalytic material may adsorb at least 2.1 mg of formaldehyde per gram of CeO₂. In one embodiment, the photocatalytic material may adsorb at least 4.2 mg of formaldehyde per gram of CeO₂. In some embodiments, the adsorption of the formaldehyde to the CeO₂ increases the oxidation/conversion of formaldehyde to CO₂ and water.

Some photocatalysts include oxide semiconductors, for example CeO₂, MnO₂ and modifications thereof. Photocatalysts can be synthesized by those skilled in the art by a variety of methods including solid state reaction, combustion, solvothermal synthesis, flame pyrolysis, plasma synthesis, chemical vapor deposition, physical vapor deposition, ball milling, and high energy grinding. In some embodiments, the photocatalyst can be at least 70%, 75%, 80%, 85%, 90%, 95%, and/or 99% of a first photocatalyst. In some embodiments, the photocatalyst may range between about 70%, 75%, 80%, 85%, 90%, 95%, 99%, or 100% of a first photocatalyst. In some embodiments, the photocatalytic composite comprises about 1% to about 99% visible light photocatalytic material, as described above, e.g., CeO₂ and/or MnO₂, and correspondingly about 99% to about 1% non-photocatalytic material. In some embodiments, the non-photocatalytic material may be oxides having a photocatalytic activity of less than 10%, 5%, 1%, and/or 0.5% of CeO₂ and/or MnO₂ activity. In some embodiments, the non-photocatalytic material may be Al₂O₃.

In some embodiments, a photocatalyst further comprises at least one naturally occurring element, e.g., non-noble gas elements. In some embodiments, the photocatalyst material may include or be doped or loaded with at least one naturally occurring element, e.g., non-noble gas elements. Doped elements may be provided as precursors added generally during synthesis.

In some embodiments, the photocatalyst further comprises at least one metal. In some embodiments, the photocatalyst may be loaded with at least one metal. Photocatalysts can be loaded with metals by post synthesis methodologies like impregnation, photo-reduction, and sputtering. As a preferred embodiment, loading metals on photocatalysts may be carried out as described in U.S. Patent Publication No. 2008/0241542 which is incorporated herein in its entirety by reference. In some embodiments, the element loaded on the photocatalyst may be a noble element. In some embodiments, the element loaded on the photocatalyst may be at least one noble element, oxide, and/or hydroxide. In some embodiments, the noble elements may be platinum, palladium, gold, silver, iridium, ruthenium, rhodium, or their oxides and/or hydroxides thereof. In some embodiments, the element loaded on the photocatalyst may comprise a transition metal, or an oxide, and/or hydroxides thereof. In some embodiments, an element loaded on the photocatalyst may be selected from transition metals such as iron, copper, nickel, or their oxides and/or hydroxides thereof. In some embodiments, the element loaded on the photocatalyst may be chosen from different groups of elements including at least one transition metal and at least one noble metal or their respective oxides and/or hydroxides.

A method for decomposing an aldehyde, e.g., formaldehyde, may comprise contacting the aldehyde, e.g., formaldehyde, with a visible light photocatalyst composition comprising a metal oxide. For some materials, photocatalysis may be due to reactive species (able to perform reduction and oxidation) being formed on the surface of the photocatalyst from the electron-hole pairs generated in the bulk of the photocatalyst by absorption of electromagnetic radiation.

An aldehyde to be removed/decomposed is not particularly limited and may include, for example, formaldehyde (including paraformaldehyde), acetaldehyde (including paracetaldehyde), propionaldehyde, butyl aldehyde, amyl aldehyde, hexyl aldehyde, heptyl aldehyde, 2-ethylhexyl aldehyde, cyclohexyl aldehyde, furfural, glyoxal, glutaraldehyde, benzaldehyde, 2-methylbenzaldehyde, 3-methylbenzaldehyde, 4-methylbenzaldehyde, β-hydroxybenzaldehyde, m -hydroxybenzaldehyde, phenylacetaldehyde, and β-phenylpropionaldehyde. These aldehydes may be removed singly, or two or more kinds may also be removed in combination. In one embodiment, formaldehyde can be removed.

In some embodiments, removing/decomposing an aldehyde may include oxidizing an aldehyde, such as oxidizing formaldehyde. In some embodiments, the aldehyde may be oxidized to form carbon dioxide and water. In some embodiments, the aldehyde may be substantially entirely oxidized into carbon dioxide and water. In some embodiments, at least 70%, 75%, 80%, 85%, 90%, 95%, 97%, or 99% of the aldehyde may be converted into carbon dioxide and water.

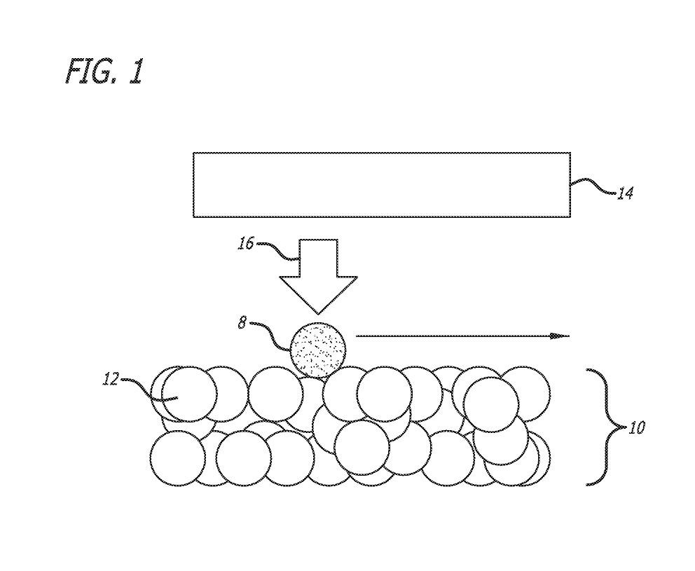

FIG. 1 is a schematic representation of a photocatalytic element 10 according to some embodiments described herein. In some embodiments, a photocatalytic element 10 may be provided including a photocatalyst 12 in contact with the aldehyde 8. In some embodiments, a light source 14 may be provided to irradiate the photocatalyst 12, as indicated by arrow 16, while in contact with the aldehyde 8, e.g., formaldehyde. In some embodiments, a photocatalytic element 10 may be provided including a substrate (not shown) and a photocatalytic composition, the composition including at least one photocatalyst material 12. In some embodiments, the photocatalytic composition is coated to a substrate in such a way that the photocatalyst composition may come into contact with light and material to be decomposed, such as formaldehyde.

In some embodiments, the source 14 may be a transparent photocatalytic composition including at least one of photoluminescent (phosphorescent or fluorescent), incandescent, electro-, chemo-, sono-, mechano-, or thermo-luminescent materials. Phosphorescent materials may include ZnS and aluminum silicate whereas fluorescent materials may include phosphors like YAG-Ce (YAG doped with Ce), Y₂O₃-Eu (yttria doped with Eu), various organic dyes, etc. Incandescent materials may include carbon and tungsten while electroluminescent materials may include ZnS, InP, GaN, etc. Many types of light generation mechanisms could be used to provide the energy to initiate photocatalysis, e.g. sunlight, fluorescent lamp, incandescent lamp, light-emitting diode (LED) based lighting, sodium vapor lamp, halogen lamp, mercury vapor lamp, noble gas discharges, and flames. In some embodiments, the irradiation emitted by the light source and optically communicated to the photocatalytic material and/or the aldehyde, such as aldehyde 8, may be from about 380 nm, about 390 nm, about 400 nm, about 410 nm, about 420 nm, or about 430 nm; and up to about 475 nm, about 495 nm, about 525 nm, or any combination of the above described emissive wavelengths. In one embodiment, the irradiation may be between about 447 nm to about 457 nm.

In some embodiments, the contacting of the photocatalyst with the aldehyde may occur below a maximum of about 90° C., about 80° C., about 70° C., about 65° C., about 50° C., about 45° C., about 40° C., and/or about 35° C.

In some embodiments, the photocatalytic composition may be disposed upon a substrate. In some embodiments, by being disposed upon the substrate, the photocatalytic composition may be a separately formed layer, formed prior to disposition upon the substrate. In another embodiment, the photocatalytic composition may be formed upon the substrate surface, e.g., by vapor deposition, like either chemical vapor deposition (CVD) or physical vapor deposition (PVD); laminating; pressing; rolling; soaking; melting; gluing; sol-gel deposition; spin coating; dip coating; bar coating; slot coating; brush coating; sputtering; thermal spraying, including flame spray, plasma spray (DC or RF); high velocity oxy-fuel spray (HVOF); atomic layer deposition (ALD); cold spraying, or aerosol deposition. In another embodiment, the photocatalytic composition may be incorporated into the surface of the substrate, e.g., at least partially embedded within the surface.

In some embodiments, the photocatalyst composition substantially covers the substrate. In some embodiment, the photocatalyst composition contacts or covers at least about 10%, at least about 25%, at least about 35%, at least about 40%, at least about 50%, at least about 60%, at least about 75%, at least about 85%, or at least about 95% of the substrate surface.

A larger surface area may translate into higher photocatalytic activity. In some embodiments, the Brunner Emmett Teller (BET) specific surface area of the photocatalyst is about 0.1-500 m²/g or about 10-50 m²/g.

In some embodiments, a photocatalytic layer is provided including the aforementioned compositions of cerium oxide/manganese oxide.

In some embodiments, a method is provided for making a photocatalytic composition including creating a dispersion comprising a photocatalyst, e.g., CeO₂, and a dispersing media; wherein the dispersion has about 2 to about 50 wt % solid materials; applying the dispersion to a substrate; and heating the dispersion and the substrate at a sufficient temperature and length of time to evaporate substantially all the dispersing media from the dispersion. In some embodiments, the dispersion is applied to cover the substrate, either in whole or in part, or to a surface of the substrate to create a coating or surface layer.

In some embodiments, there is a method for making a photocatalytic composition including mixing an aqueous dispersion of CeO₂; adding sufficient dispersing media, e.g. water, to attain a dispersion of about 10 to about 30 wt % solid materials; applying the dispersion to a substrate; and heating the substrate at a sufficient temperature and length of time to evaporate substantially all of the water from the dispersion and the substrate. In some embodiments, the CeO₂ may be a sol.

In some embodiments, the amount of dispersing media, e.g. water, added is sufficient to attain a dispersion of about 2 to about 50 wt %, about 10 to about 30 wt %, or about 15 to about 25 wt % solid materials. In some embodiments, the amount of dispersing media, e.g., water, added is sufficient to attain a dispersion of about 20 wt % solid materials

In some embodiments the mixture covered substrate is heated at a sufficient temperature and/or sufficient length of time to substantially remove the dispersing media. In some embodiments at least about 90%, at least about 95%, or at least about 99% of the dispersing media is removed. In some embodiments, the dispersion covered substrate is heated at a temperature between about room temperature and 500° C. In some embodiments, the dispersion covered substrate is heated to a temperature between about 90° C. and about 150° C. In some embodiments, the dispersion covered substrate is heated to a temperature of about 120° C. In some embodiments, the dispersion covered substrate is heated to a temperature of less than about 200° C., less than about 300° C., less than about 400° C., and/or less than about 500° C. While not wanting to be limited by any particular theory, it is believed that keeping the temperature below about 500° C. may reduce the possibility of thermal deactivation of the photocatalytic material, for example due to photocatalytic material phase change to a less active phase, dopant diffusion, dopant inactivation, loaded material decomposition, or coagulation (reduction in total active surface area).

In some embodiments, the dispersion covered substrate is heated for a time of about 10 seconds to about 2 hours. In some embodiments, the mixture covered substrate is heated for a time of about 1 hour.

The dispersions described herein can be applied to virtually any substrate. Other methods of applying the dispersion to a substrate can include slot/dip/spin coating, brushing, rolling, soaking, melting, gluing, or spraying the dispersion on a substrate. A proper propellant can be used to spray a dispersion onto a substrate.

In some embodiments, the substrate need not be capable of transmitting light. For example, the substrate may be a common industrial or household surface on which a dispersion can be directly applied. Substrates may include, glass (e.g., windows), walls (e.g., drywall), stone (e.g., granite counter tops), masonry (e.g., brick walls), metals (e.g., stainless steel), woods, plastics (e.g., plastic wrap for flowers), other polymeric surfaces, ceramics, and the like. Dispersions in such embodiments may be formulated as paints or liquid adhesives. Dispersions in such embodiments may be applied to tape, wallpapers, drapes, lamp shades, light covers, table or counter surface coverings, and the like.

A photocatalyst composition may be capable of photocatalytically decomposing an organic compound, such as an aldehyde, including acetaldehyde, formaldehyde, propionaldehyde, etc. Photocatalytic decomposition may occur in a solid, liquid, or a gas phase.

In some embodiments, the substrate comprises a gas permeable material. In some embodiments, the gas permeable material enables a minimum threshold flow rate through the substrate. In another embodiment, the gas permeable material may be porous PTFE (e.g., HEPA/ULPA Filter), non-woven or woven textile, folding filter (e.g., textile, paper, porous plastic as such as porous PTFE), glass/quartz wool, fiber (e.g., glass quartz, plastics), honeycomb structured metal or ceramic materials, or attach photocatalyst(s) onto any existing filter materials. In some embodiments, the gas permeable material is porous and/or defines pores therein and/or therethrough. In some embodiments, the gas permeable material may be ceramic. The ceramic may comprise Al₂O₃, ZrO₂, SiO₂, or other known ceramic materials. In some embodiments, the ceramic element comprises Al₂O₃. In some embodiments, the ceramic element comprises ZrO₂. In some embodiments the ceramic element comprises SiO₂. In some embodiments, the ceramic comprises other known ceramic materials known in the art.

The ceramic substrate may have porosity in the range of about 1 pore per inch (ppi) to about 50 pp; about 5 ppi to about 45 ppi; about 10 ppi to about 40 ppi; about 15 ppi to about 35 ppi; about 20 ppi to about 30 ppi; about 30 ppi, or any combination of the aforementioned ranges.

The ceramic substrate may range in thickness from about 1 mm to about 50 mm; about 1 mm thick to about 5 mm thick; about 5 mm thick to about 10 mm thick; about 10 mm thick to about 15 mm thick; about 15 mm thick to about 20 mm thick; about 20 mm thick to about 25 mm thick; about 25 mm thick to about 30 mm thick; about 30 mm thick to about 35 mm thick; about 35 mm thick to about 40 mm thick; about 40 mm thick to about 45 mm thick; about 45 mm thick to about 50 mm thick; or any thickness in a range bounded by any of these values.

In some embodiments, the effectiveness of the formaldehyde oxidizing element is increased when the formaldehyde gas contacts the photocatalytic composition while illuminated. An appropriate combination of porosity and thickness may be chosen to optimize the airflow rate in order to achieve a desired level of formaldehyde concentration.

In some embodiments, the photocatalytic composition is disposed on the porous ceramic substrate by dip coating. In some embodiments, after being dipped and dried, the element is annealed at about 400° C. for about 12 hours. Annealing improves the adhesion of the composition to the ceramic substrate and increases efficacy of the element. After the annealing process, the photocatalytic composition forms a layer of grains disposed across the ceramic matrix.

In some embodiments, the substrate comprises a thin film. Additionally, the film may be, but need not be, transparent. The film may be made of low density polyethylene (LDPE), high density polyethylene (HDPE), polypropylene (PP), polyvinyl chloride (PVC), polyethylene terephthalate (PET), polyethylene terephthalate glycol-modified (PETG), Nylon 6, ionomer, nitrile rubber modified acrylonitrile-methyl acrylate copolymer, or cellulose acetate.

In some embodiments, the thin film has a thickness of about 10 μm to about 250 μm; about 10 μm to about 30 μm; about 30 μm to about 50 μm; about 50 μm to about 70 μm; about 70 μm to about 90 μm; about 90 μm to about 110 pm; about 110 μm to about 130 μm; about 130 μm to about 150 μm; about 150 μm to about 170 μm; about 170 μm to about 190 μm; about 190 μm to about 210 μm; about 210 μm to about 230 μm; about 230 μm to about 250 μm; or any thickness in a range bounded by any of these values.

The photocatalytic composition may be disposed on the thin film substrate by various deposition means know in the art, non limiting examples including dipping, vapor deposition, liquid deposition, etc.

In some embodiments, the substrate comprises glass. The substrate may be a silicate or polycarbonate glass, or other glass typically used for windows and displays.

In some embodiments, methods are utilized wherein polluted air is exposed to light and a photocatalyst material, composition, or dispersion as described herein thereby removing aldehydes from the air.

In some embodiments, light and a photocatalyst material, composition, or dispersion may remove about 50%, about 60%, about 70%, about 80%, about 90%, about 95%, about 99% or more of the aldehydes, including formaldehyde, from the air.

In some embodiments, light and a photocatalyst material, composition, or dispersion may convert about 50%, about 60%, about 70%, about 80%, about 90%, about 95%, about 99% or more of the formaldehyde into carbon dioxide.

### Sample Preparation

All materials were used without further purification unless otherwise indicated. All materials were purchased from Sigma Aldrich (St. Louis, Mo., USA) unless otherwise indicated.

### Example 1

### Sample Preparation

Raw powdered CeO₂ (100 mg) (Nanostructured & Amorphous Materials, Inc., Houston, Tex., USA) was mixed with deionized H₂O (1 to 1.5 mL) to make a dispersion. The resulting dispersion was homogenized using an ultrasonic homogenizer for 5 min, and then coated onto the bottom of a petri dish (60 mm in diameter) pre-treated using a corona treater. The petri dish was heated on a hotplate at 90-100° C. until all liquids were evaporated.

The resulting petri dish was cleaned by simultaneous light irradiation from a Xe lamp (lamp power output 300 W) and heat treatment at 120° C. for 60 min. After cooling down to room temperature, the petri dish was sealed in a 5 L Tedlar® bag.

One additional Tedlar® bag (both control formaldehyde and control CO₂) were prepared in a manner similar to that described in Example 1 above, except that no prepared petri dishes were inserted prior to sealing.

### Example 2

### Photocatalytic Activity Measurement

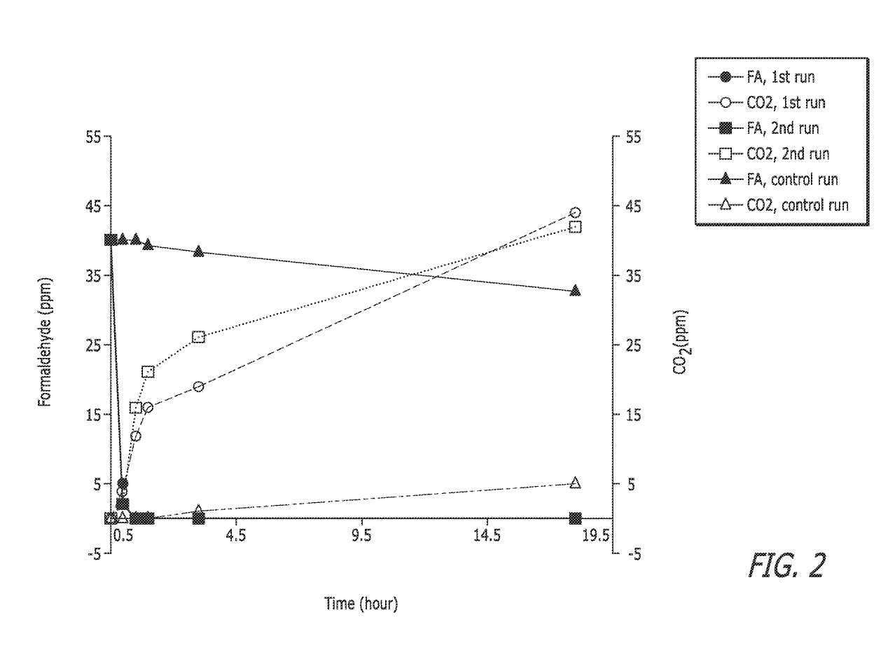

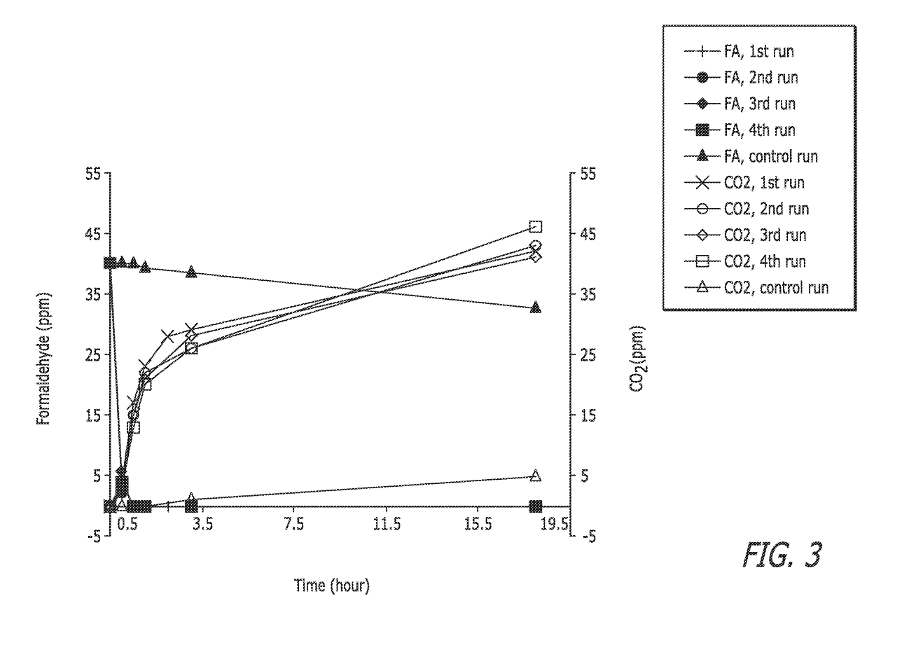

The Tedlar® bag[s] enclosing a petri dish/not enclosing a petri dish as described in Example 1 were injected with 1.2 L nitrogen (N₂) gas containing 100 ppm formaldehyde (HCHO) and 1.8 L compressed air (21% O₂, 78% N₂, 0.9% Ar) to make a 3 L gas mixture with an initial formaldehyde (HCHO) concentration at 40±4 parts per million (ppm). The Tedlar® bags were kept in dark for about 30 min before the respective petri dish was illuminated by external blue light. The concentrations of HCHO and carbon dioxide (CO₂) were measured at the beginning and the end of the dark period and at different time intervals after the blue light was switched on. The concentrations of HCHO were determined by sampling 100 mL of the gas using Gastec® detector tubes (No. 91 L). The concentrations of CO₂ were determined by sampling 10 mL of the gas using a CO₂ monitor. The external blue light was supplied by a customized blue LED array and was set up to provide a light intensity of 25 mW/cm² at the center of the petri dish. The samples were taken up to 18 h. After 18 h, the bag[s] were flushed and refilled with 100 ppm (HCHO)/1.8 L of compressed air as described above and the measurements retaken under the same previously described parameters. The results are shown in FIGS. 2 and 3. FIGS. 2 and 3 show a decreasing presence of formaldehyde with time ([solid lines] FA) with a corresponding increasing presence of CO₂ ([dashed lines] CO₂) with comparison to the formaldehyde and/or CO₂ levels in the control groups.

### Example 3

### Photocatalytic Conversion of Formaldehyde

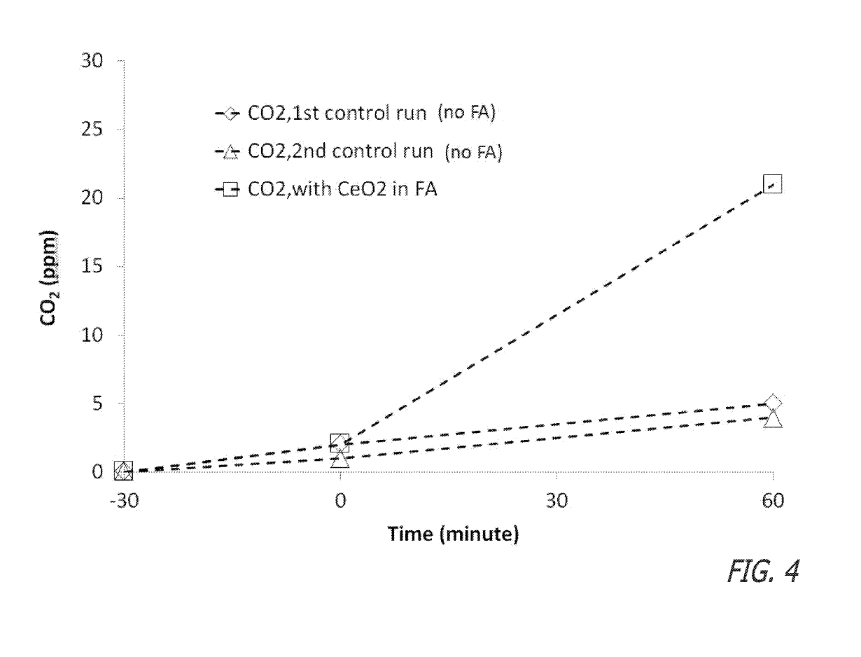

Example 3 was prepared and tested in a manner similar to that described in Examples 1 and 2 above. This is shown in FIG. 4 as “CO₂, with CeO₂ in FA”. In addition, Example 3 was tested in a manner similar to that described in Examples 1 and 2, except that no formaldehyde was inserted into the Tedlar® bag in two cases (1^{st} and 2^{nd} controls). These are shown in FIG. 4 as CO2, 1^{st} and 2^{nd} control runs. In comparison to the case with 40 ppm formaldehyde, the amounts of CO₂ increase at a much slower rate. The difference is clearly from the photocatalytic decomposition of formaldehyde to CO₂. FIG. 4 shows an increasing amount of CO₂ after 60 min of exposure to CeO₂. FIG. 4 shows about 16 ppm CO₂ more at 60 min, which is considered to be from the photocatalytic formaldehyde decomposition. Such activity is equivalent to about 2.1 μmol formaldehyde per 100 mg CeO₂ per hour.

### Example 4

### Loading of Platinum (Prophetic)

The loading of platinum will be carried out via an impregnation method. The weight ratio of Pt to CeO₂ will be set to be 1 to 100. Tetraamineplatinum (II) nitrate (Pt(NH₃)₄(NO₃)₂) (4.5 mg) will be mixed with deionized H₂O (8 mL) in a vial reactor to make a solution. After the addition of raw CeO₂ (0.2 g) (Nanostructured & Amorphous Materials, Inc., Houston, Tex., USA) to the solution, the vial reactor will be heated in a silicone oil bath at 90° C. under rigorous stirring for 1 h. An aqueous solution (2 mL) containing NaOH (25 mg) and glucose (125 mg) will be then added to the reaction mixture in the vial reactor. The reaction mixture will be kept in silicone oil bath for another 1 h. After cooling down to room temperature, the mixture will be filtered through 0.05 μm membrane, washed with 50 to 100 mL deionized H₂O, dried at 110° C. in an air oven overnight (16 to 18 h), and finally annealed in a muffled furnace at 400° C. for 1 h. It is anticipated that CeO₂ loaded with Pt will also exhibit formaldehyde decomposing ability.

### Embodiments

The following embodiments are contempated:

Embodiment 1. A method for removing formaldehyde comprising:

contacting a sample with a composition comprising a visible light photocatalyst comprising a metal oxide that is adsorbent to aldehydes, and wherein the metal of the metal oxide has an atomic number of 23 to 80; and

exposing the sample to light between about 380 nm to about 525 nm.

Embodiment 2. The method of embodiment 1, wherein the metal oxide is ZnO, ZrO₂, SnO₂, CeO₂, SrTiO₃, BaTiO₃, In₂O₃, CuₓO, Fe₂O₃, ZnS, WO₃, Mn_{y}Oₓ, TiO₂, CoₓO, or V₂O₅, wherein x is 1, 2, or 3, and y is 1, 2, or 3.

Embodiment 3. The method of embodiment 1, wherein the metal oxide is cerium oxide or manganese oxide.

Embodiment 4. The method of embodiment 1, 2, or 3, wherein the composition further comprises a noble metal.

Embodiment 5. The method of embodiment 4, wherein the noble metal is platinum, palladium, gold, silver, iridium, ruthenium, or rhodium.

Embodiment 6. The method of embodiment 4, wherein the noble metal is platinum.

Embodiment 7. An element for removing formaldehyde from a sample comprising:

a photocatalytic element comprising a visible light photocatalyst comprising a metal oxide that is adsorbent to aldehydes, wherein the metal of the metal oxide has an atomic number of 23 to 80; and

an irradiating element, wherein the irradiating element is in optical communication with the sample and cerium oxide with light between about 380 nm and 525 nm.

Embodiment 8. The element of embodiment 7, wherein the photocatalytic and adsorbent metal oxide is ZnO, ZrO₂, SnO₂, CeO₂, SrTiO₃, BaTiO₃, In₂O₃, CuₓO, Fe₂O₃, ZnS, WO₃, Mn_{y}Oₓ, TiO₂, CoₓO, or V₂O₅, wherein x is 1, 2, or 3, and y is 1, 2, or 3.

Embodiment 9. The element of embodiment 7, wherein the photocatalytic and adsorbent metal oxide is cerium oxide or manganese oxide.

Embodiment 10. The element of embodiment 7, 8, or 9, wherein the composition further comprises a noble metal.

Embodiment 11. The element of embodiment 10, wherein the noble metal is platinum, palladium, gold, silver, iridium, ruthenium, or rhodium.

Embodiment 12. The element of embodiment 10, wherein the noble metal is platinum.

Embodiment 13. A device for removing an aldehyde from air comprising: the element of embodiment 7, 8, 9, 10, or 11; wherein the photocatalytic element is in fluid communication with the air containing the aldehyde to be removed.

Embodiment 14. The device of embodiment 13, wherein further comprising the aldehyde adsorbed onto the photocatalytic element.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques.

The terms “a,” “an,” “the” and similar referents used in the context of describing embodiments of the disclosure (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the embodiments disclosed herein and does not pose a limitation on the scope of any claim. No language in the specification should be construed as indicating any non-claimed element essential to the practice of the embodiments disclosed herein.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments are described herein, including the best mode known to the inventors for carrying out the embodiments of the present disclosure. Of course, variations on these described embodiments will become apparent to those of ordinary skill in the art upon reading the foregoing description. The inventor expects skilled artisans to employ such variations as appropriate, and the inventors intend for the embodiments of the present disclosure to be practiced otherwise than specifically described herein. Accordingly, the claims include all modifications and equivalents of the subject matter recited in the claims as permitted by applicable law. Moreover, any combination of the above-described elements in all possible variations thereof is contemplated unless otherwise indicated herein or otherwise clearly contradicted by context.

In closing, it is to be understood that the embodiments disclosed herein are illustrative of the principles of the claims. Other modifications that may be employed are within the scope of the claims. Thus, by way of example, but not of limitation, alternative embodiments may be utilized in accordance with the teachings herein. Accordingly, the claims are not limited to embodiments precisely as shown and described.

1. A method for removing formaldehyde comprising:
contacting a sample with a composition comprising a visible light photocatalyst comprising a metal oxide that is adsorbent to aldehydes, and wherein the metal of the metal oxide has an atomic number of 23 to 80; and
exposing the sample to light between about 380 nm to about 525 nm.

2. The method of claim 1, wherein the metal oxide is ZnO, ZrO₂, SnO₂, CeO₂, SrTiO₃, BaTiO₃, In₂O₃, CuₓO, Fe₂O₃, ZnS, WO₃, Mn_{y}Oₓ, TiO₂, CoₓO, or V₂O₅, wherein x is 1, 2, or 3, and y is 1, 2, or 3.

3. The method of claim 1, wherein the metal oxide is cerium oxide or manganese oxide.

4. The method of claim 1, wherein the composition further comprises a noble metal.

5. The method of claim 4, wherein the noble metal is platinum, palladium, gold, silver, iridium, ruthenium, or rhodium.

6. The method of claim 4, wherein the noble metal is platinum.

7. An element for removing formaldehyde from a sample comprising:
a photocatalytic element comprising a visible light photocatalyst comprising a metal oxide that is adsorbent to aldehydes, wherein the metal of the metal oxide has an atomic number of 23 to 80; and
an irradiating element, wherein the irradiating element is in optical communication with the sample and cerium oxide with light between about 380 nm and 525 nm.

8. The element of claim 7, wherein the photocatalytic and adsorbent metal oxide is ZnO, ZrO₂, SnO₂, CeO₂, SrTiO₃, BaTiO₃, In₂O₃, CuₓO, Fe₂O₃, ZnS, WO₃, Mn_{y}Oₓ, TiO₂, CoₓO, or V₂O₅, wherein x is 1, 2, or 3, and y is 1, 2, or 3

9. The element of claim 7, wherein the photocatalytic and adsorbent metal oxide is cerium oxide or manganese oxide.

10. The element of claim 7, wherein the composition further comprises a noble metal.

11. The element of claim 10, wherein the noble metal is platinum, palladium, gold, silver, iridium, ruthenium, or rhodium.

12. The element of claim 10, wherein the noble metal is platinum.

13. A device for removing an aldehyde from air comprising:
the element of claim 7, wherein the photocatalytic element is in fluid communication with the air containing the aldehyde to be removed.

14. The device of claim 13, wherein further comprising the aldehyde adsorbed onto the photocatalytic element.
